(19) United States
(12) Patent Application Publication
(10) Pub. No.: US 2010/0207901 A1
(43) Pub. Date: Aug. 19, 2010

(54) MOBILE TERMINAL WITH TOUCH FUNCTION AND METHOD FOR TOUCH RECOGNITION USING THE SAME

(75) Inventor: Chul Seon SHIN, Seoul (KR)

Correspondence Address: H.C. PARK & ASSOCIATES, PLC, 8500 LEESBURG PIKE, SUITE 7500, VIENNA, VA, 22182, US

(73) Assignee: Pantech Co., Ltd., Seoul (KR)

(21) Appl. No.: 12/705,013

(22) Filed: Feb. 12, 2010

(30) Foreign Application Priority Data
Feb. 16, 2009 (KR) 10-2009-0012413

(51) Int. Cl. G06F 3/033; G06F 3/041

(52) U.S. Cl. 345/173; 715/863

(57) ABSTRACT

A mobile terminal includes a touch panel, and can be operated in a selection mode or a gesture mode. If a touch signal is inputted with the mobile terminal in the selection mode, the mobile terminal executes a selected command. If the touch signal is inputted with the mobile terminal in the gesture mode, the mobile terminal executes a command mapped to a pattern corresponding to the touch signal's inputted pattern. The mobile terminal may include a touch mode setting unit that sets the selection mode or gesture mode. The mobile terminal may identify whether the touch signal is a selection signal or a gesture signal based on the number of touch points. If only one point is touched, the touch signal may be considered a selection signal. If more than one point is touched, the touch signal may be considered a gesture signal.

### CROSS-REFERENCE TO RELATED APPLICATION

This application claims priority from and the benefit of Korean Patent Application No. 10-2009-0012413, filed on Feb. 16, 2009, which is hereby incorporated by reference for all purposes as if fully set forth herein.

### BACKGROUND

1. Field of Disclosure

This disclosure relates to a mobile terminal, and more particularly, to a mobile terminal having a touch function, and a method for touch recognition in the mobile terminal to recognize a touch mode.

2. Discussion of the Background

As mobile communication techniques and infrastructures have developed, mobile terminals continue to improve as media for providing various services such as games, messaging (SMS and MMS), Internet search, wireless data communications, PDAs, digital cameras, and video phone calls, as well as voice calls.

Recently, attempts have been made to improve users' convenience by employing graphic user interface (GUI) similar to that used in a personal computer (PC) or a touch panel to a mobile terminal.

A mobile terminal having a touch function includes a touch panel as a user interface. The touch panel inputs a command by generating a predetermined voltage signal or a current signal at a position pressed by a user with a touch pen, stylus, or a finger.

However, the existing touch panel simply replaces functions of a keypad in a mobile terminal. Thus, it limitedly performs functions of recognizing commands inputted by the user using a touch pen or a finger and does not provide various applications for improving users' convenience.

### SUMMARY

Exemplary embodiments of the present invention provide a mobile terminal and a touch recognition method of the mobile terminal to recognize a touch mode as a selection command or a gesture command.

Additional features of the invention will be set forth in the description which follows, and in part will be apparent from the description, or may be learned by practice of the invention.

An exemplary embodiment of the present invention discloses a mobile terminal, including: a touch panel; a touch mode setting unit to activate one of a selection mode and a gesture mode according to a mode selection signal; a selection command executor to execute a command selected by a touch signal in the selection mode; and a gesture command executor to recognize an inputted pattern corresponding to a touch signal in the gesture mode, and to execute a command mapped to a predefined pattern if the inputted pattern corresponds to the predefined pattern.

An exemplary embodiment of the present invention discloses a mobile terminal, including: a touch panel; a touch mode identifier to recognize whether a touch signal applied to the touch panel is a selection signal or a gesture signal based on a number of actually touched points; a selection command executor to execute a selection command corresponding to a first touch point if the touch mode identifier recognizes the touch signal as the selection signal; and a gesture command executor to recognize an inputted pattern at a second touch point of the touch signal, and to execute a gesture command mapped to a predefined pattern corresponding to the inputted pattern if the touch mode identifier recognizes the touch signal as the gesture signal.

An exemplary embodiment of the present invention discloses a method for touch recognition in a mobile terminal including a touch panel. The method includes defining gestures by mapping predefined patterns to commands; if a mode selection signal is inputted, activating one of a selection mode and a gesture mode according to the mode selection signal; receiving a touch signal by the touch panel; if the touch signal is inputted to the touch panel while the mobile terminal is in the selection mode, executing a command selected by the touch signal; and if the touch signal including an inputted pattern is inputted to the touch panel while the mobile terminal is in the gesture mode, executing a command mapped to a predefined pattern corresponding to the inputted pattern.

An exemplary embodiment of the present invention discloses a method for touch recognition in a mobile terminal including a touch panel. The method includes defining gestures by mapping predefined patterns to commands; receiving a touch signal by the touch panel; identifying whether the touch signal is a selection signal or a gesture signal based on a number of actually touched points; executing a selection command corresponding to a first touch point if the touch signal is identified as the selection signal; and recognizing an inputted pattern at a second touch point of the touch signal, and executing a gesture command mapped to a predefined pattern corresponding to the inputted pattern if the touch signal is identified as the gesture signal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a view schematically illustrating the configuration of a mobile terminal having a touch function according to an exemplary embodiment of the present invention.

FIG. 2(a) and FIG. 2(b) are views illustrating a mobile terminal having a touch function in use, according to an exemplary embodiment of the present invention.

FIG. 3 is a flowchart of a method for touch recognition in a mobile terminal according to an exemplary embodiment of the present invention.

FIG. 4 is a view schematically illustrating the configuration of a mobile terminal having a touch function according to an exemplary embodiment of the present invention.

FIG. 5(a) and FIG. 5(b) are views illustrating a mobile terminal having a touch function in use, according to an exemplary embodiment of the present invention.

FIG. 6 is a flowchart illustrating a method for touch recognition in a mobile terminal according to an exemplary embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

Hereinafter, a mobile terminal having a touch function and a method for touch recognition in a mobile terminal according to exemplary embodiments will be described in more detail with reference to the accompanying drawings.

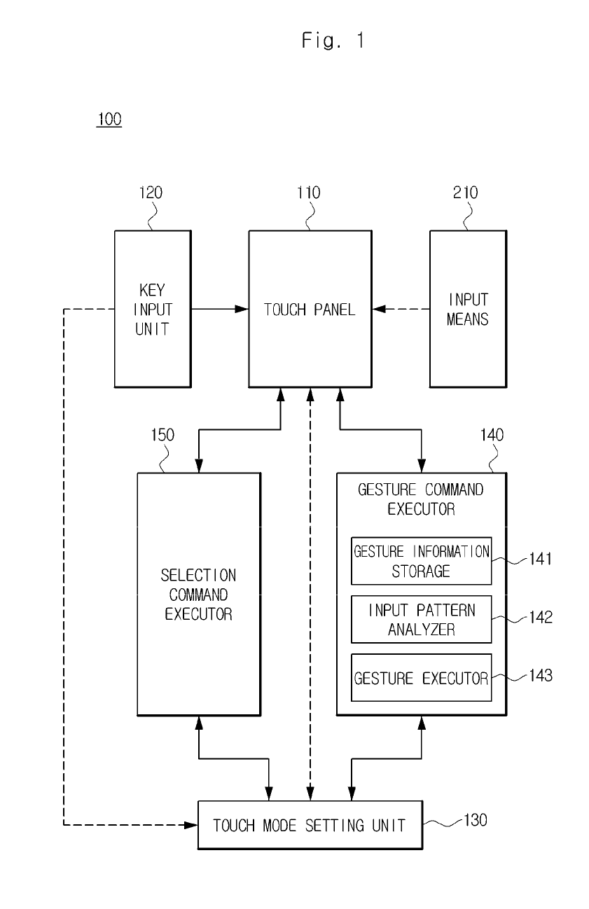

FIG. 1 is a view schematically illustrating the configuration of a mobile terminal having a touch function according to an exemplary embodiment of the present invention.

Referring to FIG. 1, the mobile terminal 100 includes a touch panel 110, a key input unit 120 to generate an input to the touch panel 110, a touch mode setting unit 130, a gesture command executor 140, and a selection command executor 150.

The touch panel 110 generates touch panel data according to a touch input of a user, and displays the process result of the operation corresponding to the input on a screen, thereby providing a touch function to the user. Here, the touch panel data includes space coordinate data, pattern data, and the like, which are resources used for the selection command executor 150 or a gesture executor 140 to recognize an operation intended by a user.

Information on a state associated with the mobile terminal 100 and various types of information generated during the operation of the mobile terminal 100 are displayed on the touch panel 110. For example, a battery level of the mobile terminal 100, a receiving signal intensity level, date and time, a dialed phone number, texts, moving images, still images, and the like may be displayed individually or in some combination. Since the touch panel 110 may include an analog-to-digital (A/D) converter, an analog signal outputted from the touch panel 110 is converted into touch panel data of a digital data type to be outputted. The touch panel data converted into data and outputted from the touch panel 110 is applied to the selection command executor 150 or the gesture command executor 140.

The key input unit 120 is a part where mechanical keys provided in a body of the mobile terminal 100 are positioned. The key input unit 120 may include buttons for the numbers 0 to 9 for dialing and functional keys having associated functions such as a menu button, a cancel button (clear), an OK button, a TALK button, an END button, an Internet connection button, a navigation key (or direction key), and play-related buttons (▴/▾/ [symbol] / [symbol] ). The keys described above may not be mechanical key buttons but be provided as virtual keys displayed on the screen of the touch panel 110. In this case, the key input unit 120 may be minimized or omitted.

The input device 210 may be a touch pen, stylus, or a user's finger or thumb, and the user may select the menus, buttons, functions, or the like displayed on the screen of the touch panel 110 by using the input device 210.

The mobile terminal 100 of FIG. 1 allows the user to use the touch function through the touch panel 110. The touch function of the mobile terminal 100 includes a selection function of selecting a menu or executing a desired operation by pressing a button by the user, and a gesture function of executing a desired function by inputting a touch corresponding to pattern on the screen of the touch panel 110 by the user.

For example, the user inputs a gesture in a particular pattern by moving the input device 210 upward, downward, left, or right while touching the screen of the touch panel 110 (the gesture function). Otherwise, the user selects a desired function by touching a particular position on the screen with the input device 210 and then detaching the input device 210 from the touch panel 110 without moving the input device 210 between the touch and released touch (the selection function).

Here, the selection function may be implemented by a combination of sequential operations including a “pen-down” movement for touching the touch panel 110 with the input device 210 and a “pen-up” movement for detaching the input device 210 from the touch panel 110. The gesture function may be implemented by a combination including a “pen-down” movement for pressing the screen of the touch panel 110 using the input device 210 and a “pen-move” movement for moving the input device 210 while pressing the screen of the touch panel 110. However, the pen-up and the pen-move may occur after the pen-down movement. The mobile terminal 100 recognizes movements after the pen-down movement. Thus, there is a possibility that the movements performed after the pen-down movement will be recognized differently from an intention of the user. For example, the user may perform the pen-down and pen-up with the intention of performing a selection function, but if a slight movement between the pen-down and the pen-up occurs, the movement may be wrongly recognized as a gesture function.

If a mode selection signal is inputted from the key input unit 120 or the touch panel 110 by a manipulation of a user, the touch mode setting unit 130 may selectively activate one of the selection mode and the gesture mode depending on the mode selection signal. That is, by enabling the touch mode setting unit 130 to selectively activate the selection mode or the gesture mode, it is possible to prevent a malfunction in which the mobile terminal 100 wrongly recognizes the touch of the user contrary to the intention of the user. The user may generate a mode selection signal for setting or changing a mode by pressing a mechanical mode button provided in the key input unit 120 or touching a virtual mode button displayed on the screen of the touch panel 110 as a graphic interface.

Thus, a malfunction occurring because the mobile terminal 100 incorrectly recognizes the selection or the gesture when receiving a signal depending on the touch may be reduced by using the touch mode setting unit 130.

The touch mode setting unit 130 registers the present touch mode of the mobile terminal 100. Depending on the value of the touch mode setting unit 130 set by the mode selection signal, the touch mode of the mobile terminal 100 may be set to one of the selection mode and the gesture mode. Otherwise, a change from the selection mode to the gesture mode or from the gesture mode or the selection mode may be made.

For example, the value 0 of the touch mode setting unit 130 may be defined as the selection mode, the value 1 may be defined as the gesture mode, and a mechanical mode button for setting entry/cancellation of the gesture mode may be implemented on the key input unit 120. In this case, when the user presses the mode button, the value of the touch mode setting unit 130 changed from the default value 0 to 1, and the mobile terminal 100 enters the gesture mode. When the mode button is pressed again, the value of the touch mode setting unit 130 is returned to 0, and the mode is changed to the selection mode. In the selection mode, when there is a slight movement of the input device 210 after the pen-down, the touch may not be recognized as the pen-move, thereby reducing the risk of a malfunction.

The gesture command executor 140 defines gestures by mapping predefined patterns to commands. When the user inputs a touch signal through the touch panel 110 in a state where the gesture mode is activated, the gesture command executor 140 analyzes the pattern inputted by the user by using the touch signal in the gesture mode and checks whether a predefined pattern from among the patterns registered in advance matches with the inputted pattern. If the inputted pattern matches with a pre-defined particular pattern, the gesture command executor 140 executes a command mapped to the pre-defined particular pattern matching the pattern inputted by the user. Here, the touch signal in the gesture mode may be a combination of signals generated by continuously performing the pen-down movement for pressing the touch panel 110 with the input device 210 by the user and the pen-move movement for drawing a particular pattern while pressing the touch panel 110 with the input device 210.

The gesture command executor 140 may include a gesture information storage 141, an input pattern analyzer 142, and a gesture executor 143.

The gesture information storage 141 defines various gestures by mapping plural patterns to commands to be executed when the corresponding patterns are inputted, and by storing them.

The input pattern analyzer 142 analyzes the input pattern according to the pen-move and checks whether a predefined pattern from among the patterns registered in the gesture information storage 141 matches with the inputted pattern.

If a predefined pattern matches with the analysis result of the pattern input by the pen-move, the gesture executor 143 executes the command mapped to the predefined pattern matching the inputted pattern.

When the selection mode is activated, the selection command executor 150 executes the command selected by the touch signal in the selection mode. Typically, the touch signal in the selection mode may be a combination of signals generated by the pen-down and the pen-up. In this case, by sequentially performing the pen-down movement for pressing the touch panel 110 using the input device 210, and the pen-up movement for detaching the input device 210 from the touch panel 110, the selection function (for example, executing an icon at a point touched by the user) may be performed. Otherwise, the touch signal in the selection mode may be a signal generated by the pen-down movement. In this case, in the selection mode, the selection function (for example, executing an icon at a point touched by the user) may be executed upon detecting the pen-down movement for pressing the touch panel 110 with the input device 210 by the user.

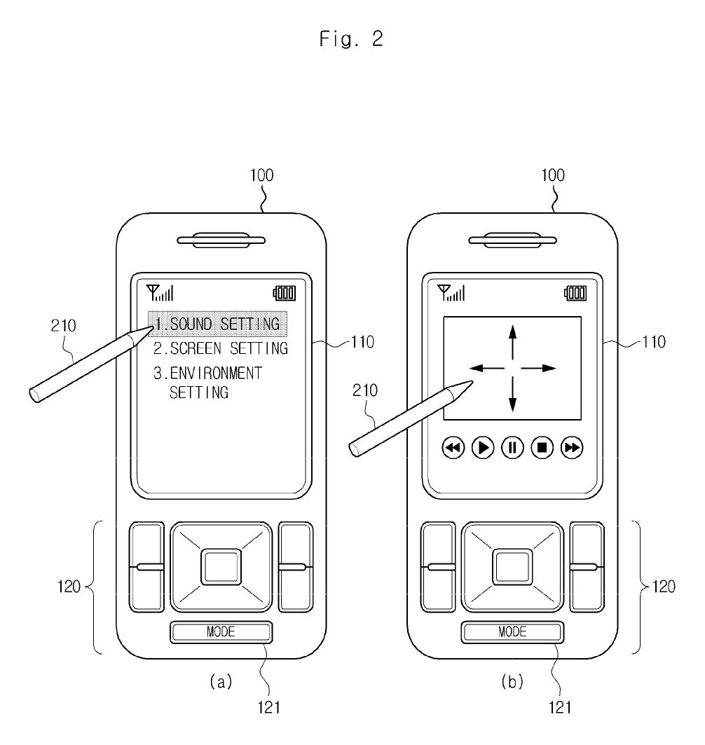

FIG. 2(a) and FIG. 2(b) are views illustrating a mobile terminal having a touch function in use, according to an exemplary embodiment of the present invention.

A touch mode setting unit 130 may be implemented in one of various forms. For example, the touch mode setting unit 130 may be a mode button for entering the gesture mode or the selection mode. As the mode button, a mechanical button 121 as illustrated in FIG. 2(a) and FIG. 2(b) may be used, a flip-switch or sliding switch (not shown) may be used, or a virtual button displayed on a part of the screen of the touch panel 110 may be used. The position of the virtual button is not limited.

As a typical touch movement of the user, the pen-down movement for pressing the touch panel 110, the pen-move movement for a movement while pressing the touch panel 110, the pen-up movement for a detachment from the touch panel 110, and the like may be defined. In addition, the selection movement and the gesture movement may be defined by combining the above-mentioned movements.

FIG. 2 (a) and FIG. 2 (b) illustrate the selection movement and the gesture movement, respectively. Selection is a movement for selecting a sub-menu or a specific function (e.g., 1. Sound Setting) displayed on the touch panel 110 as illustrated in FIG. 2 (a). During the selection, the user may select a desired menu or a function on the screen of the touch panel 110 by performing the pen-down movement, in order to execute the menu or the function selected by the user.

Gesture is a movement for performing the pen-move as illustrated in FIG. 2 (b) to input upward, downward, left, and right functions (e.g., selecting the next song or the previous song during a music play mode, moving the screen to an upper or lower folder, or the like) by moving the input device 210 on the screen of the touch panel 110. During the gesture, the user maintains the touch, and performs the pen-move movement to draw a predetermined pattern matched with a command such as up, down, left, right, end, and previous on the screen of the touch panel 110. The mobile terminal 100 recognizes the pattern inputted to the touch panel 110 and performs the command mapped to a predefined pattern corresponding to the inputted pattern.

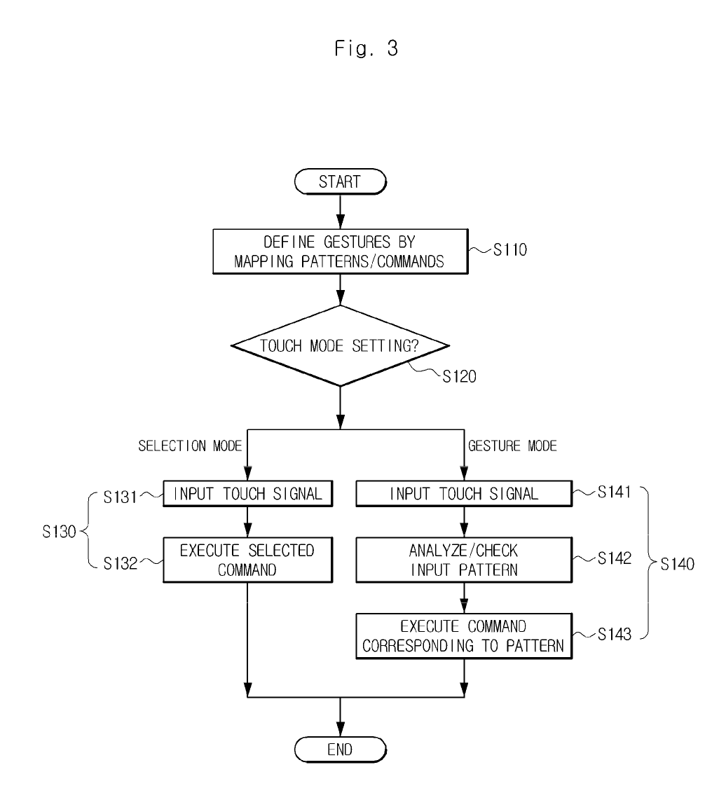

FIG. 3 is a flowchart of a method for touch recognition in a mobile terminal according to an exemplary embodiment of the present invention.

The mobile terminal 100 defines gestures by mapping plural predetermined patterns with the corresponding commands and registering them in the gesture information storage 141 (S110).

As the user performs a movement such as pressing the mode button 121, the mode selection signal for selectively activating one of the selection mode and the gesture mode is generated. The value of the touch mode setting unit 130 is set to one of the selection mode and the gesture mode depending on the mode selection signal, and the selection command executor 150 or the gesture command executor 140 is activated depending on the set mode (S120).

When the touch signal is inputted through the touch panel 110 of the mobile terminal 100 (S131) in a state where the selection mode is activated (S130), the selection command executor 150 of the mobile terminal 100 executes the command selected by the input touch signal (S132). Here, the touch signal in the selection mode may be generated by the pen-down movement for pressing the touch panel 110 with the input device 210 and the pen-up movement for detaching the input device 210 from the touch panel 110. Otherwise, the touch signal for executing the selection function may be generated by only the pen-down movement for pressing the touch panel 110 with the input device 210.

When the touch signal including a particular pattern is inputted through the touch panel 110 of the mobile terminal 100 (S141) in a state where the gesture mode is activated (S140), the gesture command executor 140 of the mobile terminal 100 analyzes whether a pattern matching with the particular pattern inputted by the user exists from among the plural patterns pre-registered in the gesture information storage 141 (S142). If the pattern matching with the input pattern is registered, the gesture command executor 140 executes the command mapped to the predefined pattern corresponding to the inputted pattern (S143). Here, the touch signal in the gesture mode may be generated in the case where the pen-down movement for pressing the touch panel 110 with the input device 210 and the pen-move movement for drawing a particular pattern while pressing the touch panel 110 with the input device 210 are performed.

As described above, a mobile terminal 100 may include a touch mode identifier to identify whether a touch mode is a selection mode or a gesture mode. Therefore, there may be a reduced risk that a user's input is received in a touch mode contrary to the user's intention.

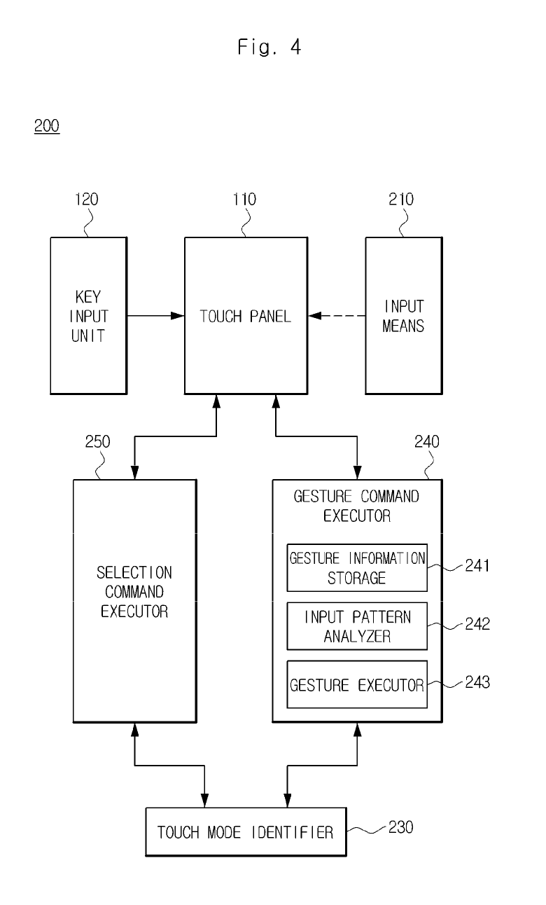

FIG. 4 is a view schematically illustrating the configuration of a mobile terminal having a touch function according to an exemplary embodiment of the present invention.

Referring to FIG. 4, the mobile terminal 200 includes a touch panel 110, a key input unit 120, a touch mode identifier 230, a gesture command executor 240, and a selection command executor 250. In this embodiment, the touch panel 110, the key input unit 120, and the input device 210 correspond to those of the exemplary embodiment described with reference to FIG. 1. Therefore, a detailed description thereof will be omitted.

If a touch signal is inputted through the touch panel 110, the touch mode identifier 230 identifies whether the touch signal is a selection signal or a gesture signal on the basis of the number of points where the touch panel 110 is actually touched. In addition, the touch mode identifier 230 activates and operates the selection command executor 250 or the gesture command executor 240 according to the identification result. Specifically, if only a single point is touched on the touch panel 110, the touch mode identifier 230 may recognize the inputted touch signal as the selection signal. To the contrary, if two or more points are touched on the touch panel 110, the touch mode identifier 230 may recognize the latest-inputted touch signal or the touch signal corresponding to a predefined location of the touch panel as the gesture signal.

If the touch mode identifier 230 identifies the touch signal inputted by the user as the selection signal (for example, when the user touches only a single point on the touch panel 110), the selection command executor 250 is activated. Here, the selection command executor 250 executes the selection command corresponding to the position of the point where the touch signal is recognized.

On the other hand, if the touch mode identifier 230 identifies the touch signal inputted by the user as the gesture signal (for example, when the user simultaneously or consecutively touches other points while one point on the touch panel 110 is already touched by the user), the gesture command executor 240 is activated. The gesture command executor 240 defines the gestures by mapping the predefined patterns with the commands. If the touch mode identifier 230 recognizes the touch signal inputted by the user as the gesture signal, it recognizes the particular pattern of the touch signal, and executes the gesture command mapped to a predefined pattern corresponding to the particular inputted pattern.

The gesture command executor 240 may include a gesture information storage 241, an input pattern analyzer 242, and a gesture executor 243.

The gesture information storage 241 defines various gestures for implementing various functions by matching plural patterns designated by the user, a designer, a manager, or the like with commands to be performed when the corresponding patterns are inputted, and storing them.

The input pattern analyzer 242 recognizes the touch signal inputted later as the pen-move instead of the pen-up to analyze the pen-move pattern, and checks whether a pattern matching with the inputted pattern exists from among the predefined patterns registered in the gesture information storage 241 for defining the gestures. For example, when touches are simultaneously or consecutively detected at two points on the touch panel 110 as the user touches a point while touching another point, the detected touch signals are recognized as the gesture signal.

If a predefined pattern matching with the inputted pattern analysis result of the input pattern analyzer 242 is defined in the gesture command executer 240, the gesture executor 243 executes the gesture command mapped to the predefined pattern corresponding to the inputted pattern.

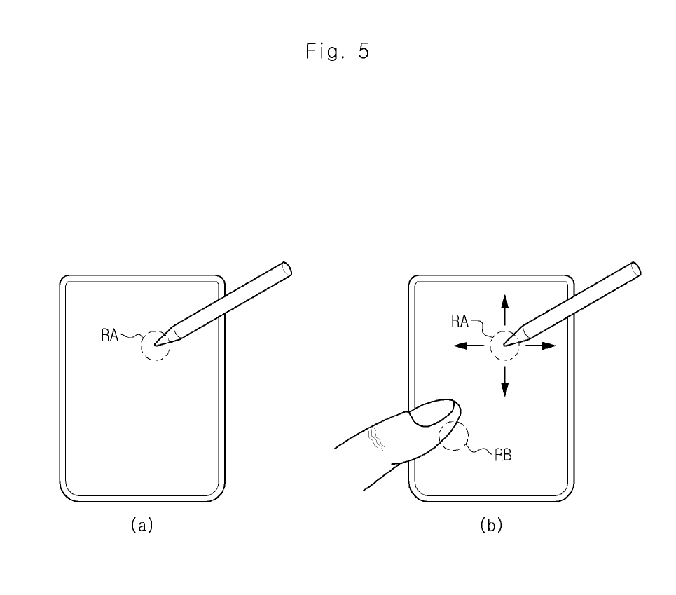

FIG. 5(a) and FIG. 5(b) are views illustrating a mobile terminal having a touch function in use, according to an exemplary embodiment of the present invention.

If two or more points are touched on the touch panel 110, the mobile terminal 200 may recognize the detected touch signal as the gesture mode. If the touch is detected at only a single point, the mobile terminal 200 may recognize the touch signal as the selection mode.

If a touch is detected at only a single point on the touch panel 110, the selection command executor 250 of the mobile terminal 200 may recognize the touch signal as the selection signal, and operates to execute the selection command by executing an object (for example, an icon) at the touch point. For example, as illustrated in FIG. 5 (a), if the user touches a music player icon at an arbitrary point RA on the touch panel 110 by using a touch pen as the input device 210, the mobile terminal 200 recognizes the touch signal as the selection command, executes the music player icon at the point RA, and displays a music player window on the screen.

If the touch is detected only at the single point RA, the mobile terminal 200 recognizes the touch signal at the point RA as the signal of the selection mode. Therefore, even if there is a slight movement of the input device 210 such as a slip of a finger on the touch panel 110, the risk that the mobile terminal 200 will recognize an operation that is not intended by the user may be reduced.

On the other hand, if a touch is detected at two or more points on the touch panel 110, the gesture command executor 240 may recognize the particular pattern inputted at the point touched later to execute the gesture command mapped to the predefined pattern corresponding to the recognized particular pattern or to move an object (for example, an icon) existing at the point touched later. For example, in FIG. 5 (b), the user touches a single point RB on the touch panel 110 with a finger of one hand, and simultaneously or shortly thereafter touches the music player icon at another point RA by using the input device 210 such as another finger or a touch pen. As touches are detected at the two points RA and RB, the mobile terminal 200 may recognize the touch signal inputted at the point RA which is touched later as the gesture command and move the music player icon existing at the point RA along the movement of the input device 210. If the music player has been executed, the state of the music player which is being executed may be changed according to the particular pattern inputted at the point RA (for example, volume control, play, stop, pause, and the like).

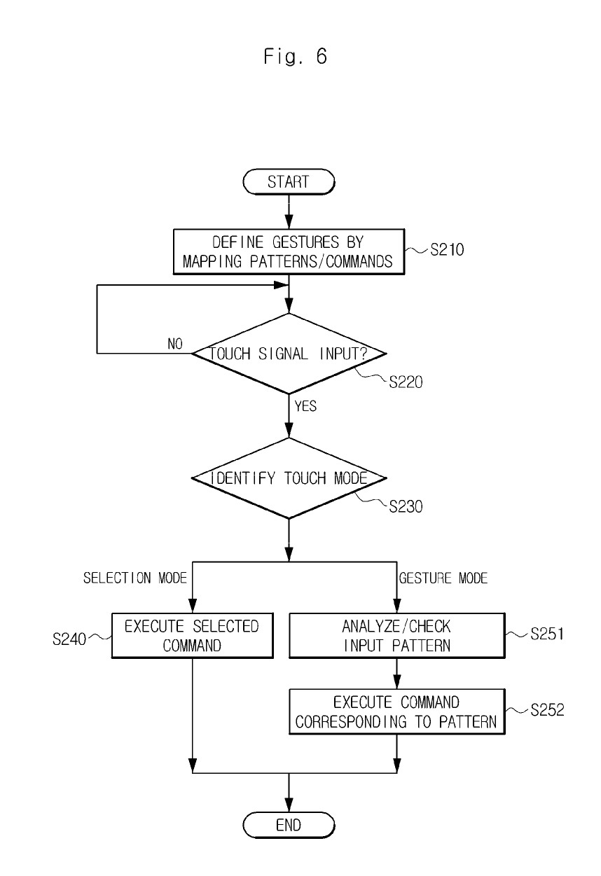

FIG. 6 is a flowchart illustrating a method for touch recognition in a mobile terminal according to an exemplary embodiment of the present invention.

The mobile terminal 200 defines the gestures by mapping the predefined patterns with the commands (S210).

When the user inputs a touch signal by touching one or more points on the touch panel 110 of the mobile terminal 200 (S220), the mobile terminal 200 identifies whether the touch signal is the selection signal or the gesture signal on the basis of the number of points where the touch panel 110 is actually touched (S230). Here, the mobile terminal 200 may recognize the detected touch signal as the selection signal in the case where only a single point is touched on the touch panel 110, and may recognize the detected touch signal as the gesture signal if two or more points are touched on the touch panel 110.

If the detected touch signal is recognized as the selection signal, the mobile terminal 200 operates in the selection mode and executes the selection command corresponding to the point where the touch signal is detected (S240). Here, the selection command may be a command for executing the object such as an icon existing at the touched point where the touch is detected only at the single point on the touch panel 110. For example, when the user touches a single point where the music player icon exists, the mobile terminal 200 may operate in the selection mode and execute the corresponding icon.

If the detected touch signal is recognized as the gesture signal, the mobile terminal 200 operates in the gesture mode and recognizes the particular pattern of the latest-detected touch signal (S251), and executes the gesture command mapped to the predefined pattern corresponding to the recognized inputted pattern (S252). Here, the gesture command may be a command for recognizing the particular pattern inputted at the latest-touched point, and executing the command mapped to the predefined pattern corresponding to the particular pattern or moving the object existing at the latest-touched point depending on the recognition result. For example, the user may touch and drag the music player icon with one finger while the user touches an arbitrary point with a second finger. In this case, instead of playing the music player as in the selection mode, the mobile terminal 200 operates in the gesture mode and moves the music player icon along the movement of the second finger to another position or controls the volume of the music being played while the music player is executed.

While the exemplary embodiments have been shown and described, it will be understood by those skilled in the art that various changes in form and details may be made thereto without departing from the spirit and scope of this disclosure as defined by the appended claims and their equivalents.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims and their equivalents.

What is claimed is:

1. A mobile terminal, comprising:
a touch panel;
a touch mode setting unit to activate one of a selection mode and a gesture mode according to a mode selection signal;
a selection command executor to execute a command selected by a touch signal in the selection mode; and
a gesture command executor to recognize an inputted pattern corresponding to a touch signal in the gesture mode, and to execute a command mapped to a predefined pattern if the inputted pattern corresponds to the predefined pattern.

2. The mobile terminal of claim 1, wherein the touch signal in the selection mode is generated by a first movement to press the touch panel and a second movement to release the pressed state of the touch panel.

3. The mobile terminal of claim 1, wherein the touch signal in the selection mode is generated by a first movement to press the touch panel.

4. The mobile terminal of claim 1, wherein the touch signal in the gesture mode is generated by a first movement to press the touch panel and a second movement while maintaining the pressed state of the touch panel.

5. A mobile terminal, comprising:
a touch panel;
a touch mode identifier to recognize whether a touch signal applied to the touch panel is a selection signal or a gesture signal based on a number of actually touched points;
a selection command executor to execute a selection command corresponding to a first touch point if the touch mode identifier recognizes the touch signal as the selection signal; and
a gesture command executor to recognize an inputted pattern at a second touch point of the touch signal, and to execute a gesture command mapped to a predefined pattern corresponding to the inputted pattern if the touch mode identifier recognizes the touch signal as the gesture signal.

6. The mobile terminal of claim 5, wherein the touch mode identifier recognizes the touch signal as the selection signal if only the first touch point is touched on the touch panel, and recognizes the touch signal as the gesture signal if the second touch point and another touch point are touched on the touch panel.

7. The mobile terminal of claim 5, wherein the selection command executor executes an object displayed at the first touch point if the touch mode identifier recognizes the touch signal as the selection signal.

8. The mobile terminal of claim 5, wherein the gesture command executor recognizes the inputted pattern at the second touch point, and executes the gesture command mapped to the predefined pattern corresponding to the inputted pattern or moves an object displayed at the second touch point.

9. A method for touch recognition in a mobile terminal comprising a touch panel, the method comprising:
defining gestures by mapping predefined patterns to commands;
if a mode selection signal is inputted, activating one of a selection mode and a gesture mode according to the mode selection signal;
receiving a touch signal by the touch panel;
if the touch signal is inputted to the touch panel while the mobile terminal is in the selection mode, executing a command selected by the touch signal; and
if the touch signal including an inputted pattern is inputted to the touch panel while the mobile terminal is in the gesture mode, executing a command mapped to a predefined pattern corresponding to the inputted pattern.

10. The method of claim 9, wherein the touch signal in the selection mode is generated by a first movement to press the touch panel and a second movement to release the pressed state of the touch panel.

11. The method of claim 9, wherein the touch signal in the selection mode is generated by a first movement to press the touch panel.

12. The method of claim 9, wherein the touch signal in the gesture mode is generated by a first movement to press the touch panel and a second movement while maintaining the pressed state of the touch panel.

13. A method for touch recognition in a mobile terminal comprising a touch panel, the method comprising:
defining gestures by mapping predefined patterns to commands;
receiving a touch signal by the touch panel;
identifying whether the touch signal is a selection signal or a gesture signal based on a number of actually touched points;
executing a selection command corresponding to a first touch point if the touch signal is identified as the selection signal; and
recognizing an inputted pattern at a second touch point of the touch signal, and executing a gesture command mapped to a predefined pattern corresponding to the inputted pattern if the touch signal is identified as the gesture signal.

14. The method of claim 13, wherein the touch signal is identified as the selection signal if only the first touch point is touched on the touch panel, and identifies the touch signal as the gesture signal if the second touch point and another touch point are touched on the touch panel.

15. The method of claim 13, wherein executing the selection command comprises executing an object displayed at the first touch point.

16. The method of claim 13, wherein executing the gesture command comprises executing the gesture command mapped to the predefined pattern corresponding to the inputted pattern or moving an object displayed at the second touch point.
